(19) United States
(12) Patent Application Publication
(10) Pub. No.: US 2025/0042134 A1
(43) Pub. Date: Feb. 6, 2025

(54) SHIELDED CEILING TILE

(71) Applicant: Xalon RF Shielding Systems, Rocky River, OH (US)

(72) Inventors: Michael J. Jach, Avon Lake, OH (US); Dave Kysela, Rocky River, OH (US); Christopher Kysela, Rocky River, OH (US)

(21) Appl. No.: 18/793,805

(22) Filed: Aug. 3, 2024

Related U.S. Application Data
(60) Provisional application No. 63/530,574, filed on Aug. 3, 2023.

(51) Int. Cl. B32B 15/08; B32B 15/20; B32B 37/18; E04B 1/92

(52) U.S. Cl. CPC B32B 15/08; B32B 15/20; B32B 37/182; E04B 1/92; B32B 2307/202; B32B 2307/212; B32B 2311/12; B32B 2311/24; B32B 2419/00; E04B 2001/925

(57) ABSTRACT

A shielded ceiling tile includes a support backing including an electrically-conductive material. The shielded ceiling tile includes an interior portion attached to the support backing. The interior portion includes a synthetic material. The shielded ceiling tile includes an electrically-conductive layer attached to, and in electrical communication with, the support backing. The electrically-conductive layer is in contact, and electrical communication, with a grid member that is electrically grounded and supports the shielded ceiling tile such that the electrically-conductive layer is positioned between the grid member and the support backing. The support backing and the electrically-conductive layer are electrically-connected to the grounded grid member such that the support backing and the electrically-conductive layer form a shield.

### CROSS-REFERENCE TO RELATED APPLICATIONS

This application claims the benefit of priority of U.S. Provisional Application Ser. No. 63/530,574 filed on Aug. 3, 2023 the contents of which are relied upon and incorporated herein by reference in their entirety as if fully set forth below.

### FIELD

The present disclosure relates generally to a ceiling tile and, more particularly, to a shielded ceiling tile.

### BACKGROUND

It is known to provide a ceiling tile above a room. However, existing ceiling tiles lack certain characteristics that would add value and functionality.

### SUMMARY

The following presents a simplified summary of the disclosure to provide a basic understanding of some aspects described in the detailed description.

In aspects, a shielded ceiling tile comprises a support backing comprising an electrically-conductive material. The shielded ceiling tile comprises an interior portion attached to the support backing. The interior portion comprises a synthetic material. The shielded ceiling tile comprises an electrically-conductive layer attached to, and in electrical communication with, the support backing. The electrically-conductive layer is in contact, and electrical communication, with a grid member that is electrically grounded and supports the shielded ceiling tile such that the electrically-conductive layer is positioned between the grid member and the support backing. The support backing and the electrically-conductive layer are electrically-connected to the grounded grid member such that the support backing and the electrically-conductive layer are configured to form a shield.

In aspects, the interior portion is attached to a support surface of the support backing.

In aspects, the electrically-conductive layer comprises an electrically-conductive tape that is adhered to the support surface of the support backing.

In aspects, the electrically-conductive layer extends around an outer perimeter of the support backing and does not cover an inner region of the support backing.

In aspects, the interior portion is positioned at the inner region of the support backing such that the interior portion is surrounded by the electrically-conductive layer.

In aspects, a thickness of the electrically-conductive layer is less than a thickness of the support backing and less than a thickness of the interior portion.

In aspects, the electrically-conductive layer comprises copper.

In aspects, the support backing comprises aluminum.

In aspects, methods of manufacturing a shielded ceiling tile comprise attaching an interior portion to a support backing, the support backing comprising an electrically-conductive material, the interior portion comprising a synthetic material. Methods comprise attaching an electrically-conductive layer to the support backing such that the electrically-conductive layer and the support backing are electrically connected. Methods comprise positioning the electrically-conductive layer in contact with a grid member that is electrically grounded such that the grid member supports the shielded ceiling tile, and the electrically-conductive layer is positioned between the grid member and the support backing, the support backing and the electrically-conductive layer electrically-connected to the grounded grid member such that the support backing and the electrically-conductive layer form a shield.

In aspects, the interior portion is attached to a support surface of the support backing.

In aspects, the electrically-conductive layer comprises an electrically-conductive tape that is adhered to the support surface of the support backing.

In aspects, the electrically-conductive layer extends around an outer perimeter of the support backing and does not cover an inner region of the support backing.

In aspects, the interior portion is positioned at the inner region of the support backing such that the interior portion is surrounded by the electrically-conductive layer.

In aspects, a thickness of the electrically-conductive layer is less than a thickness of the support backing and less than a thickness of the interior portion.

In aspects, the electrically-conductive layer comprises copper.

In aspects, the support backing comprises aluminum.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a room and a ceiling tile in accordance with aspects of the disclosure;

FIG. 2 illustrates an example ceiling tile in accordance with aspects of the disclosure; and

FIG. 3 illustrates a side view of the example ceiling tile in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The words “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising,” “including,” and variations thereof shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

The present disclosure relates to a shielded ceiling tile (hereinafter “tile”). As used herein, the term “shielded” can refer to radio frequency (RF) shielding, radio frequency interference (RFI) shielding, and electromagnetic interference (EMI) shielding, wherein an electromagnetic field (EMF) can be reduced or blocked due to the presence of the tile. In this way, the tile can minimize electromagnetic interference (e.g., by reducing the coupling of electrostatic fields, electromagnetic fields, magnetic fields, electric fields, radio waves, microwaves etc.). In general, the tile can function as part of a Faraday cage.

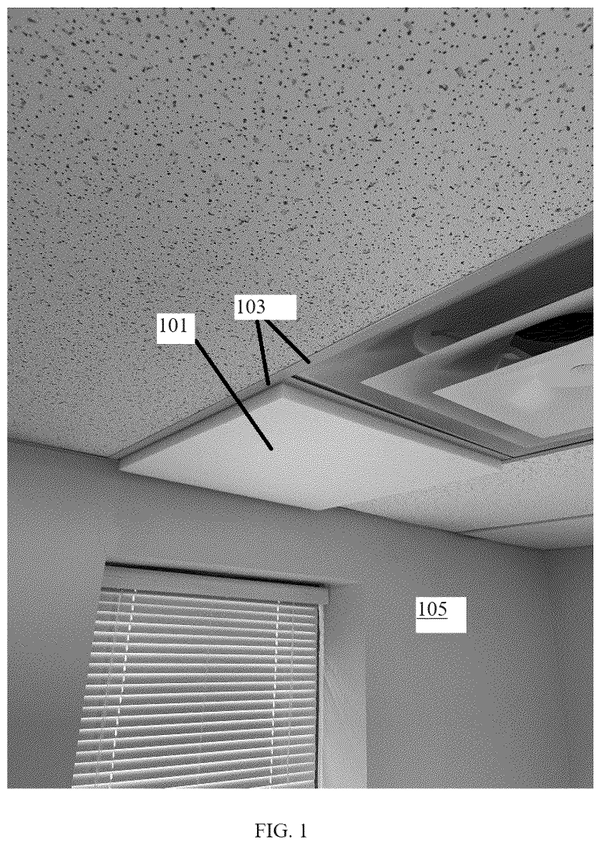

FIG. 1 illustrates a perspective view of a ceiling, wherein the tile 101 is supported by a grid 103 comprising a plurality of grid members. Together, the tile 101 and the grid 103 can form a shielded ceiling tile assembly. The tile 101 can comprise a suspended ceiling panel or the like that may be received within a grid opening defined by grid members of the grid 103. The tile 101 can reduce radiated electromagnetic emissions from entering or exiting an RF shielded room through the suspended ceiling. In addition, the tile 101 can reduce any electromagnetic interference (EMI) and radio frequency interference (RFI) that is inside of an RF shielded room 105. While the focus of the present disclosure is on a single tile 101, the room 105 can comprise a plurality of tiles that are similar or identical in structure and function to the tile 101. That is, the ceiling can comprise additional tiles that are substantially identical in structure and function to the tile 101, such that the other tiles can also function to reduce radiated electromagnetic emissions.

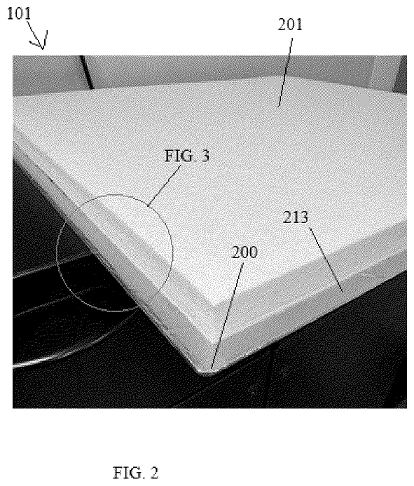

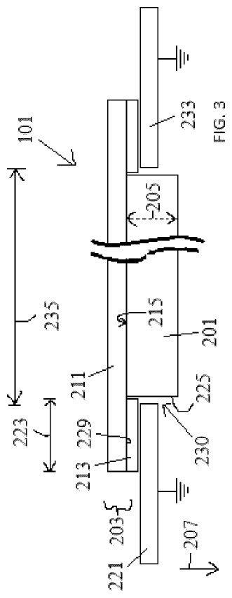

FIGS. 2 and 3 illustrate the tile 101. For example, the tile 101 can comprise an interior portion 201 and a support portion 203. As illustrated in FIG. 3, the interior portion 201 can comprise a thickness 205 (e.g., measured parallel to a direction of gravitational force 207). The interior portion 201 (e.g., ceiling panel, etc.) can comprise several types of synthetic materials, such as, for example, vinyl, expanded polystyrene, or other building materials or other synthetic ceiling materials that can provide benefits related to acoustics, aesthetics, etc.

The support portion 203 can be attached to the interior portion 201, such that the interior portion 201 and the support portion 203 can comprise a single, one-piece, unitary structure. The support portion 203 can comprise a support backing 211 and an electrically-conductive layer 213. The support backing 211 may extend partially, or completely, across a top surface 215 of the interior portion 201, with the support backing 211 attached to the top surface 215. In this way, the support backing 211 and the interior portion 201 can be attached together. The support backing 211 and the interior portion 201 can be attached together in several ways, such as with an adhesive (e.g., a spray adhesive) or the like. The support backing 211 can comprise several types of material that provide structural support to the tile 101 and allow the tile 101 to be supported on a grid member 221 of the grid 103. For example, the support backing 211 can comprise metal materials as an example. In a possible example, the support backing 211 can comprise an aluminum material, though other possible materials may comprise stainless steel, galvanized steel, copper, or the like. In this way, the support backing 211 can comprise an electrically-conductive material and may function as a shield. The thickness of the support backing 211 can be increased or decreased depending on the amount of electrical shielding that is required. For example, increasing the thickness of the support backing 211 can increase the amount of electrical shielding.

The support backing 211 can extend a distance 223 beyond a perimeter 225 of the interior portion 201. In this way, the support backing 211 can engage the grid member 221 while allowing for the interior portion 201 to pass through grid openings in the grid 103 and extend downwardly along the direction of gravitational force 207. In aspects, the interior portion 201 can function as a light reflective and noise reducing structure to reduce the amount of reflected noise within the room 105 while increasing the Sound Transmission Coefficient (STC) and Noise Isolation Class (NIC) of the tiles 101. The tiles 101 can further reduce the Reverberation Time (RT) within the room 105, thus allowing for a more favorable environment for people within the room 105.

The support portion 203 can comprise the electrically-conductive layer 213 that is attached to the support backing 211. For example, the electrically-conductive layer 213 can be attached to a support surface 229 of the support backing 211. The support surface 229 can face downwardly (e.g., relative to the direction of gravitational force 207) and may face (and/or be in contact with and/or attached to) the interior portion 201. In this way, when the tile 101 is supported by the grid member 221, the support portion 203 can rest upon the grid member 221 (e.g., and the other grid members of the grid 103). That is, the grid members 103, 221 may be positioned below or underneath the support portion 203 relative to the direction of gravitational force 207. In aspects, corners 200 (e.g., illustrated in FIG. 2) of the tile 101 can comprises a rounded or curved shape comprising a radius. Alternatively, the corners 200 can comprise a perpendicular, non-rounded shape.

The electrically-conductive layer 213 can be in contact with the grid member 221 due to the support portion 203 resting upon the grid member 221. In aspects, the support backing 211 can apply a downward compressive force onto the electrically-conductive layer 213 to push the electrically-conductive layer 213 toward the grid members 103, 221, 233 and maintain the electrically-conductive layer 213 in contact with the grid members 103, 221, 233. For example, the support backing 211 is located above the electrically-conductive layer 213 relative to the direction of gravity 207. As such, the weight of the support backing 211 can apply a downward force to the electrically-conductive layer 213 to bias the electrically-conductive layer 213 toward, and into contact with, the grid members 103, 221, 233. As such, contact, and, thus, an electrical connection, is maintained between the electrically-conductive layer 213 and the grid members 103, 221, 233.

In aspects, the electrically-conductive layer 213 can be positioned to extend around an outer perimeter of the support backing 211, such that the electrically-conductive layer 213 does not cover an inner region of the support backing 211. Instead, the interior portion 201 is positioned at the inner region of the support backing 211 such that the interior portion 201 is surrounded by the electrically-conductive layer 213. Accordingly, the electrically-conductive layer 213 can form an annular shape or ring-like shape that extends along the outer perimeter of the support backing 211 while not covering the interior or inner region of the support backing 211. The width of the electrically-conductive layer 213 may, therefore, be less than a width of the interior portion 201. The thickness of the electrically-conductive layer 213 may be less than a thickness of the support backing 211 and less than a thickness of the interior portion 201.

The electrically-conductive layer 213 can comprise any number of materials that are electrically-conductive (e.g., material that allows the flow of charge or electric current through the material). For example, the electrically-conductive layer 213 can comprise a metal material such as one or more of copper, beryllium copper, aluminum, silver, nickel, graphite, tin, combinations of materials, or other electrically-conductive materials. In aspects, the electrically-conductive layer 213 can be adhered to the support surface 229 such that the electrically-conductive layer 213 is positioned between, and in contact with, the grid member 221 on a below/bottom side and the support backing 211 on a top/above side.

In aspects, the electrically-conductive layer 213 can comprise an electrically-conductive tape or adhesive that is adhered to the support surface 229. For example, when the electrically-conductive layer 213 comprises a tape or adhesive, the electrically-conductive layer 213 may comprise an adhesive (e.g., a pressure-sensitive acrylic conductive adhesive, for example) that can adhere to the support surface 229. In aspects, when the electrically-conductive layer 213 comprises a tape or adhesive, the electrically-conductive layer 213 can comprise an electrically-conductive pressure-sensitive adhesive (PSA) backed copper tape. Alternatively, the electrically-conductive layer 213 can comprise a fabric-over-foam RF shielded gasket or a foil-over-foam RF shielded gasket. In yet another example, the electrically-conductive layer 213 can comprise an electrically-conductive coating or paint that is applied to the support surface 229. In aspects, the electrically-conductive layer 213 can comprise a 0.11×0.32 copper finger stock. In another example, the electrically-conductive layer 213 can comprise a 0.40″×0.40″ compressive foam gasket with conductive fabric. In aspects, the electrically-conductive layer 213 can comprise a thickness that is within a range from about 0.1 inches to about 0.5 inches, or 0.2 inches to about 0.4 inches, or about 0.2 inches to about 0.3 inches, or about 0.25 inches.

The grid members 103, 221, 233 which are formed from an electrically-conductive material, are electrically grounded (e.g., electrically connected to ground) and can function as a common return path for electric current. In this way, the electrically-conductive layer 213 can be electrically-connected or bonded and RF sealed to the grid members 103, 221, 233, which can facilitate shielding. The support backing 211 comprises an electrically-conductive material and can function as a shield to electrically shield the room 105. In this way, the electrically-conductive layer 213 can function to electrically-connect the support backing 211 and the grid members 103, 221, 233.

The electrically-conductive layer 213 and the support backing 211, by being electrically-connected to the grounded grid members 103, 221, can function as an electromagnetic shield that reduces or redirects an EMF within the RF shielded room 105. In this way, EMF shielding can reduce electromagnetic interference, coupling of radio waves, electromagnetic and/or electrostatic fields. In addition, or in the alternative, the electrically-conductive layer 213 and the support backing 211, by being electrically-connected to the grounded grid members 103, 221, can function as an RF shield by blocking radio frequency electromagnetic radiation. As such, the electrical connection between the tiles 101 and the grounded grid members 103, 221 can function as a Faraday cage that blocks electrostatic fields within the room 105. In aspects, the RF shielding effectiveness performance may be at least about 60 decibels and from 10 megahertz (MHz) to 10 gigahertz (GHz). The electrically-conductive layer 213 can extend around an entire perimeter of the tile 101, thus providing a leak-free RF seal.

In aspects, the grid members 103, 221 can be spaced apart to form a grid opening 230 within which a portion of the tile 101, for example, the interior portion 201, can be received. For example, the grid opening 230 can be defined between the grid member 221 and an opposing, spaced apart, grid member 233 of the grid 103. In this way, the grid opening 230 can comprise an opening width 235 that is the distance between the grid members 221, 233. The opening width 235 can comprise any number of sizes, such as, for example, sizes within a range from about one foot (e.g., about 30 centimeters) to about six feet (e.g., about 182 centimeters). In aspects, the grid opening 230 can comprise a square shape, such as with a length and width that are each about 2 feet (e.g., about 61 centimeters) for a 2 foot by 2 foot grid opening. Alternatively, the grid opening 230 can comprise a rectangular shape, such as with a width of about 2 feet (e.g., about 61 centimeters) and a length of about 4 feet (e.g., about 122 centimeters) for a 2 foot by 4 foot grid opening. It will be appreciated that the tiles 101 and the grid openings 230 could comprise other sizes and shapes, and are not limited to the sizes and shapes described herein. To accommodate for different sizes and perimeter pieces, the tile(s) 101 can be produced and delivered as part of a kit, wherein the materials of the tile 101 (e.g., the interior portion 201, the support backing 211, the electrically-conductive layer 213, any materials for adhering or attaching, etc.). Accordingly, the tile 101 can be assembled on-site to match the pre-fab pieces, allowing for local contractors to customize the tile 101 to fit nearly any project.

In aspects, the thickness of any portions of the tile 101 can be changed based on specific requirements from a job site. For example, the thickness of the interior portion 201, the support backing 211, and/or the electrically-conductive layer 213 can be altered to accommodate requirements related to RF shielding, acoustic performance, ease of installation, etc. Further, in aspects, the tile 101 can comprise materials that are Class A fire rated. Accordingly, the tile(s) 101 and the grid members 103, 221, 233 can together form a shielded ceiling tile assembly.

It should be understood that while various aspects have been described in detail relative to certain illustrative and specific examples thereof, the present disclosure should not be considered limited to such, as numerous modifications and combinations of the disclosed features are possible without departing from the scope of the following claims.

What is claimed is:

1. A shielded ceiling tile comprising:
a support backing comprising an electrically-conductive material;
an interior portion attached to the support backing, the interior portion comprising a synthetic material; and
an electrically-conductive layer attached to, and in electrical communication with, the support backing, the electrically-conductive layer in contact, and electrical communication, with a grid member that is electrically grounded and supports the shielded ceiling tile such that the electrically-conductive layer is positioned between the grid member and the support backing, the support backing and the electrically-conductive layer electrically-connected to the grounded grid member such that the support backing and the electrically-conductive layer are configured to form a shield.

2. The shielded ceiling tile of claim 1, wherein the interior portion is attached to a support surface of the support backing.

3. The shielded ceiling tile of claim 2, wherein the electrically-conductive layer comprises an electrically-conductive tape that is adhered to the support surface of the support backing.

4. The shielded ceiling tile of claim 3, wherein the electrically-conductive layer extends around an outer perimeter of the support backing and does not cover an inner region of the support backing.

5. The shielded ceiling tile of claim 4, wherein the interior portion is positioned at the inner region of the support backing such that the interior portion is surrounded by the electrically-conductive layer.

6. The shielded ceiling tile of claim 1, wherein a thickness of the electrically-conductive layer is less than a thickness of the support backing and less than a thickness of the interior portion.

7. The shielded ceiling tile of claim 1, wherein the electrically-conductive layer comprises copper.

8. The shielded ceiling tile of claim 7, wherein the support backing comprises aluminum.

9. A method of manufacturing a shielded ceiling tile comprising:
attaching an interior portion to a support backing, the support backing comprising an electrically-conductive material, the interior portion comprising a synthetic material;
attaching an electrically-conductive layer to the support backing such that the electrically-conductive layer and the support backing are electrically connected;
positioning the electrically-conductive layer in contact with a grid member that is electrically grounded such that the grid member supports the shielded ceiling tile, and the electrically-conductive layer is positioned between the grid member and the support backing, the support backing and the electrically-conductive layer electrically-connected to the grounded grid member such that the support backing and the electrically-conductive layer form a shield.

10. The method of claim 9, wherein the interior portion is attached to a support surface of the support backing.

11. The method of claim 10, wherein the electrically-conductive layer comprises an electrically-conductive tape that is adhered to the support surface of the support backing.

12. The method of claim 11, wherein the electrically-conductive layer extends around an outer perimeter of the support backing and does not cover an inner region of the support backing.

13. The method of claim 12, wherein the interior portion is positioned at the inner region of the support backing such that the interior portion is surrounded by the electrically-conductive layer.

14. The method of claim 13, wherein a thickness of the electrically-conductive layer is less than a thickness of the support backing and less than a thickness of the interior portion.

15. The method of claim 14, wherein the electrically-conductive layer comprises copper.

16. The method of claim 15, wherein the support backing comprises aluminum.
